(19) United States
(12) Patent Application Publication
(10) Pub. No.: US 2002/0056120 A1
(43) Pub. Date: May 9, 2002

(54) Method and system for distributing video using a virtual set

(76) Inventors: Brennan J. McTernan, Fanwood, NJ (US); Adam Nemitoff, Ridgewood, NJ (US); Altay Murat, Richmond Hill, NY (US); Vishal Bangia, Jersey City, NJ (US)

Correspondence Address: BROWN, RAYSMAN, MILLSTEIN, FELDER & STEINER LLP, 900 THIRD AVENUE, NEW YORK, NY, 10022, US

(21) Appl. No.: 09/767,672

(22) Filed: Jan. 22, 2001

Related U.S. Application Data
(60) Provisional application No. 60/177,397, filed on Jan. 21, 2000.
(60) Provisional application No. 60/117,394, filed on Jan. 27, 1999.
(60) Provisional application No. 60/177,396, filed on Jan. 21, 2000.
(60) Provisional application No. 60/177,395, filed on Jan. 21, 2000.
(60) Provisional application No. 60/177,398, filed on Jan. 21, 2000.
(60) Provisional application No. 60/177,399, filed on Jan. 21, 2000.
(60) Provisional application No. 60/182,434, filed on Feb. 15, 2000.
(60) Provisional application No. 60/204,386, filed on May 15, 2000.

(51) Int. Cl. H04N 7/173

(52) U.S. Cl. 725/87

(57) ABSTRACT

Described herein are systems and methods for distributing video over a computer network. The video is generated as a set of components including a model for a virtual set in which action occurs, a video of the action compressed to eliminate some or all non-useful portions of the video, and positional data used to position the action within the virtual set and orient the viewpoint of the set. These components are transmitted as separate data items from a server to a client, with the virtual set being preferably transmitted in advance of a specific video. The client reproduces the entire video by rendering the compressed video within the virtual set using the positional data.

Applicant(s) hereby claims the benefit of the following provisional patent applications:

provisional patent application Ser. No. 60/177,397, titled “VIRTUAL SET ON THE INTERNET,” filed Jan. 21, 2000, attorney docket no. 38903-007;

provisional patent application Ser. No. 60/117,394, titled “MEDIA ENGINE,” filed Jan. 21, 2000, attorney docket no. 38903-004;

provisional patent application Ser. No. 60/177,396, titled “TAP METHOD OF ENCODING AND DECODING INTERNET TRANSMISSIONS,” filed Jan. 21, 2000, attorney docket no. 38903-006;

provisional patent application Ser. No. 60/177,395, titled “SCALABILITY OF A MEDIA ENGINE,” filed Jan. 21, 2000, attorney docket no. 38903-005;

provisional patent application Ser. No. 60/177,398, titled “CONNECTION MANAGEMENT,” filed Jan. 21, 2000, attorney docket no. 38903-008;

provisional patent application Ser. No. 60/177,399, titled “LOOPING DATA RETRIEVAL MECHANISM,” filed Jan. 21, 2000, attorney docket no. 38903-009;

provisional patent application Ser. No. 60/182,434, titled “MOTION CAPTURE ACROSS THE INTERNET,” filed Feb. 15, 2000, attorney docket no. 38903-010; and

provisional patent application Ser. No. 60/204,386, titled “AUTOMATIC IPSEC TUNNEL ADMINISTRATION,” filed May 10, 2000, attorney docket no. 38903-014.

Each of the above listed applications is incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### RELATED APPLICATIONS

This application is related to the following commonly owned patent applications, filed concurrently herewith, each of which applications is hereby incorporated by reference herein in its entirety:

application Ser. No. ______, titled “SYSTEM AND METHOD FOR ACCOUNTING FOR VARIATIONS IN CLIENT CAPABILITIES IN THE DISTRIBUTION OF A MEDIA PRESENTATION,” attorney docket no. 4700/4;

application Ser. No. ______,titled “SYSTEM AND METHOD FOR USING BENCHMARKING TO ACCOUNT FOR VARIATIONS IN CLIENT CAPABILITIES IN THE DISTRIBUTION OF A MEDIA PRESENTATION,” attorney docket no. 4700/5;

application Ser. No. ______, titled “SYSTEM AND METHOD FOR MANAGING CONNECTIONS TO SERVERS DELIVERING MULTIMEDIA CONTENT,” attorney docket no. 4700/6; and

application Ser. No. _______, titled “SYSTEM AND METHOD FOR RECEIVING PACKET DATA MULTICAST IN SEQUENTIAL LOOPING FASHION,” attorney docket no. 4700/7.

### BACKGROUND OF THE INVENTION

The invention disclosed herein relates generally to techniques for distributing multimedia content across networks. More particularly, the present invention relates to an improved system and method for distributing high resolution video from a server to one or more clients while minimizing the amount of bandwidth required for the distribution.

Current methods of video compression use much bandwidth yet provide small, low resolution images and low frame rates per second. Indeed, current video transmission technologies for distribution of video over computer networks such as the Internet attempt to treat the network as an electromagnetic medium, the medium used for broadcasting of television signals. For example, as shown in FIG. 1, a video produced for distribution over the Internet consists of a scene 10, which may have a set 12 and one or more live actors 14, recorded by a camera 16. The scene is recorded as a series of two-dimensional images 18 which are compressed and transmitted such as by streaming or multicasting to a client device 20. The resulting video is presented on the client device 20 as a small image having low resolution and fewer frames per second than a standard broadcast television video signal. The resulting video is thus lacking substantially in quality as compared to typical television signals to which consumers are accustomed.

Broadband technologies such as fiber optic lines, cable systems and cable modems, satellite transmission systems, and digital subscriber lines promise to improve the situation by increasing bandwidth substantially. However, even the increased level of bandwidth provided in broadband systems may not be sufficient for many applications, such as the distribution and display of multiple simultaneous video signals used, for example, in teleconferencing applications. Furthermore, broadband technologies will not be in widespread usage for quite some time. It is also likely that video distribution technology will continue to push and exceed the limits of the transmission system capable of carrying the signals, including broadband systems.

There is thus a need for improved systems and methods for distributing video signals which require lower bandwidth but provide improved display size and resolution.

Over the past decade, processing power available to both producers and consumers of multimedia content has increased exponentially. Approximately a decade ago, the transient and persistent memory available to personal computers was measured in kilobytes (8 bits 1 byte, 1024 bytes 1 kilobyte) and processing speed was typically in the range of 2 to 16 megahertz. Due to the high cost of personal computers, many institutions opted to utilize “dumb” terminals, which lack all but the most rudimentary processing power, connected to large and prohibitively expensive mainframe computers that “simultaneously” distributed the use of their processing cycles with multiple clients.

Today, transient and persistent memory is typically measured in megabytes and gigabytes, respectively (1,048,576 bytes=1 megabyte, 1,073,741,824 bytes=1 gigabyte). Processor speeds have similarly increased, with modem processors based on the ×86 instruction set available at speeds up to 1.5 gigahertz (approximately 1000 megahertz=1 gigahertz). Indeed, processing and storage capacity have increased to the point where personal computers, configured with minimal hardware and software modifications, fulfill roles such as data warehousing, serving, and transformation, tasks that in the past were typically reserved for mainframe computers. Perhaps most importantly, as the power of personal computers has increased, the average cost of ownership has fallen dramatically, providing significant computing power to average consumers.

The past decade has also seen the widespread proliferation of computer networks. With the development of the Internet in the late 1960's followed by a series of inventions in the fields of networking hardware and software, the foundation was set for the rise of networked and distributed computing. Once personal computing power advanced to the point where relatively high speed data communication became available from the desktop, a domino effect was set in motion whereby consumers demanded increased network services, which in turn spurred the need for more powerful personal computing devices. This also stimulated the industry for Internet Service providers or ISPs, which provide network services to consumers.

Computer networks transfer data according to a variety of protocols, such as UDP (User Datagram Protocol) and TCP (Transport Control Protocol). According to the UDP protocol, the sending computer collects data into an array of memory referred to as a packet. IP address and port information is added to the head of the packet. The address is a numeric identifier that uniquely identifies a computer that is the intended recipient of the packet. A port is a numeric identifier that uniquely identifies a communications connection on the recipient device. According to the Transmission Control Protocol, or TCP, data is sent using UDP packets, but there is an underlying “handshake” between sender and recipient that ensures a suitable communications connection is available. Furthermore, additional data is added to each packet identifying its order in an overall transmission. After each packet is received, the receiving device transmits acknowledgment of the receipt to the sending device. This allows the sender to verify that each byte of data sent has been received, in the order it was sent, to the receiving device. Both the UDP and TCP protocols have their uses. For most purposes, the use of one protocol over the other is determined by the temporal nature of the data.

Data can be viewed as being divided into two types, transient or persistent, based on the amount of time that the data is useful. Transient data is data that is useful for relatively short periods of time. For example, a television video signal consists of 30 frames of imagery each second. Thus, each frame is useful for 1/30^{th} of a second. For most applications, the loss of one frame would not diminish the utility of the overall stream of images. Persistent data, by contrast, is useful for much longer periods of time and must typically be transmitted completely and without errors. For example, a downloaded record of a bank transaction is a permanent change in the status of the account and is necessary to compute the overall account balance. Loosing a bank transaction or receiving a record of a transaction containing errors would have harmful side effects, such as inaccurately calculating the total balance of the account.

UDP is useful for the transmission of transient data, where the sender does not need to be delayed verifying the receipt of each packet of data. In the above example, a television broadcaster would incur an enormous amount of overhead if it were required to verify that each frame of video transmitted has been successfully received by each of the millions of televisions tuned into the signal. Indeed, it is inconsequential to the individual television viewer that one or even a handful of frames have been dropped out of an entire transmission. TCP, conversely, is useful for the transmission of persistent data where the failure to receive every packet transmitted is of great consequence.

Thus, there have been drastic improvements in the computer technology available to consumers of content and in the delivery systems for distributing such content. However, such improvements have not been properly leveraged to improve the quality and speed of video distribution. There is thus a need for a system and method that distributes responsibilities for video distribution and presentation among various components in a computer network to more effectively and efficiently leverage the capabilities of each part of the network and improve overall performance.

### BRIEF SUMMARY OF THE INVENTION

It is an object of the present invention to solve the problems described above associated with the distribution of video over computer networks.

It is another object of the present invention to reduce the amount of bandwidth required to deliver a video signal across a computer network.

It is another object of the present invention to so reduce the bandwidth while still improving the quality of the video transmission.

It is another object of the present invention to increase resolution of video images distributed over a computer network.

It is another object of the present invention to increase the size of a video display distributed over a computer network.

The above and other objects are achieved by distributing between a server and client the effort required to create imagery on a client device. The server sends the client three general types of data—a three-dimensional model of a virtual set, compressed video of action occurring, and positional data representing the position and orientation of the camera. The virtual set represents a relatively static environment in which different actions may occur, while the video represents a series of images changing over time, such as person talking, running, or dancing, or any other item or actor undergoing movement. The positional data allows for the proper orientation of the 3D set consistent with a given view of the action in the video.

Advantageously, the server may send one or more 3D virtual sets well in advance of any given video, and the client can store the model of the virtual set in persistent memory and can use the model with an ongoing video stream and reuse it with later video signals. This reduces the bandwidth required during transmission of the video. Additional identification data may be transmitted with a given video to associate it with a previously transmitted virtual set.

The client receiving these data items compiles them to produce a presentation. The video of the action is rendered onto two-dimensional images of the stored virtual set, such as by texture mapping, at a predefined location within the set at which the action would have occurred if done on a corresponding real set. For example, if the set is a backdrop for a news broadcast, and the video is of a person reporting the news, the video is placed at a location within the set in which the person would have sat while reporting the news. Additional video or other multimedia content may be transmitted, received and positioned at other locations within the virtual set, such as on boards behind the news reporter, using the same or similar techniques.

The video may be live action recorded by cameras or virtual action produced through the use of computer graphics. To improve performance, the video of the action is processed and compressed prior to transmission. In one embodiment, the video is matted to produce a high contrast image such as in black and white, with the white region identifying the portion of the video representing the action and the black region representing inactive portion of the video such as the background. When the video is recorded with cameras, the actor is placed before a blue screen for the filming. The video of the actor is processed with systems well known in the art that can generate a high contrast image where the white part of the image represents the area occupied by the actor and the black part of the image represents the area occupied by the blue screen. The high contrast image is then overlaid on the video to identify the active areas of the video. The video is cropped to eliminate as much of the inactive regions as practical or possible, with the remaining black, inactive portions being made transparent for overlaying on the rendered image of the virtual set.

The positional data indicates where the real camera is in relation to actor on the real set. This data is used to position the 3D Camera in the 3D set. Because the 3D camera's position and orientation match that of the camera that captured the video, the video retains its dimensionality. Some of the above and other objects of the present invention are achieved by a method for distributing video over a network for display on a client device. The method includes storing model data representing a set in which action occurs, generating video data representing action occurring, capturing positional data representing a position of one or more actors during the action in the generated video, and transmitting from a server to the client device as separate data items the model data, generated video, and positional data, to thereby enable the client to reproduce and display a video comprising the action occurring at certain positions within the set.

Some of the above and other objects of the present invention are achieved by method for receiving video over a network and presenting it on a client device. The method includes receiving from a server as separate data items model data representing a set in which action occurs, video data representing action occurring, and positional data representing a position of one or more actors during the action in the generated video. The method further involves rendering the video data within the set at a predefined position within the set determined at the time the virtual set was constructed, and presenting the video on a client device.

Objects of the invention are also achieved through a system for preparing a video for distribution over a network to one or more clients, the video containing one or more actors. The system contains a positional data capturing system for capturing position data representing a position of the camera relative to the actors in the video, a video compression system for reducing the video by eliminating all or a portion of the video not containing the actor, the video compression system including a matting system for matting the video to separate the actor from other parts of the video, and a transmission system for transmitting compressed video in association with corresponding positional data and in association with model data representing a set within which the video is rendered for presentation by one or more clients.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a flow diagram showing the prior art method for recording and distributing video over a network;

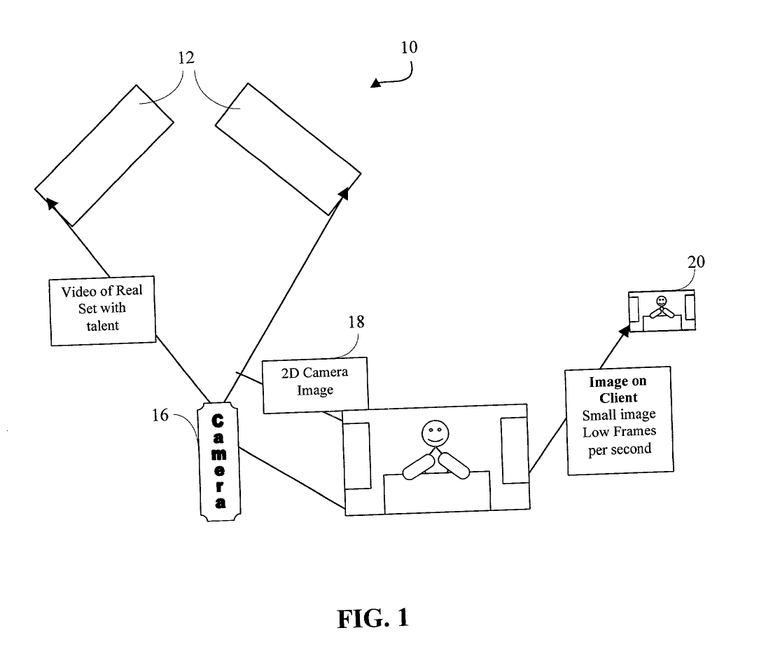

FIG. 2 is a block diagram of a system implementing one embodiment of the present invention;

FIG. 3 is a flow chart showing a process of generating and distributing video in the system of FIG. 2 in accordance with one embodiment of the present invention;

FIG. 4 is a flow diagram showing components and processes involved in the process shown in FIG. 3; and

FIG. 5 is a diagram illustrating triangulation of marker positions in accordance with one embodiment of the present invention.

### DETAILED DESCRIPTION OF THE PREFERRED EMBODIMENTS

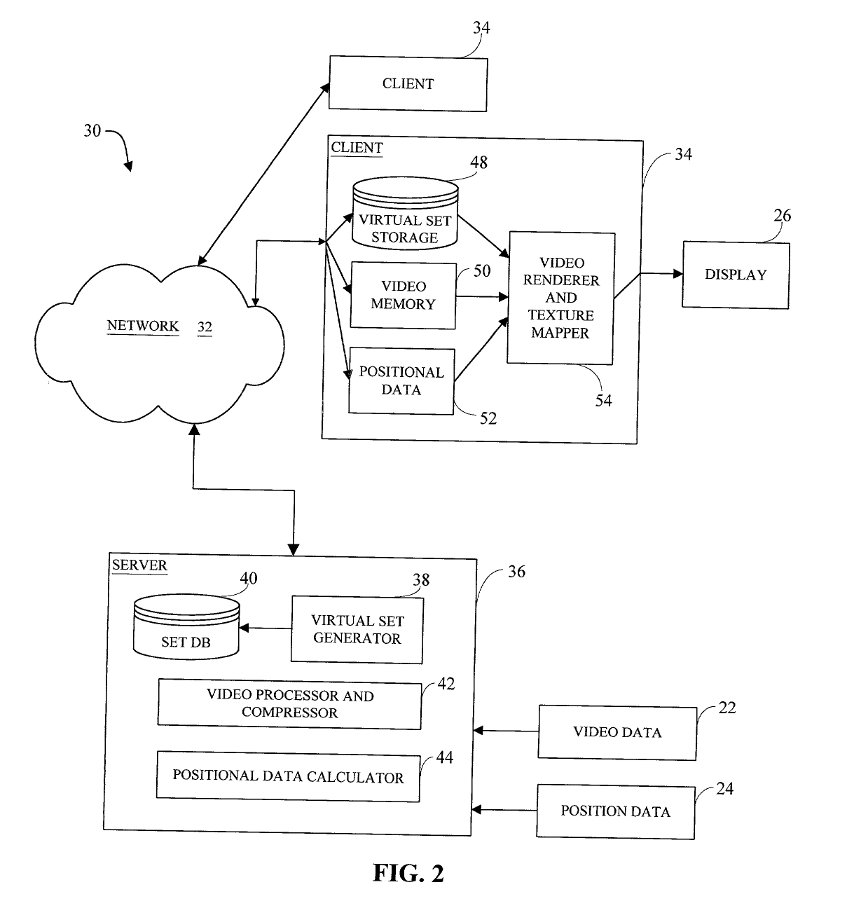

Embodiments of the present invention are now described with reference to the drawings in FIGS. 2-5. Referring to FIG. 2, a system 30 of one preferred embodiment of the invention is implemented in a computer network environment 32 such as the Internet, an intranet or other closed or organizational network. A number of clients 34 and servers 36 are connectable to the network 32 by various means, including those discussed above. For example, if the network 32 is the Internet, the servers 36 may be web servers which receive requests for data from clients 34 via HTTP, retrieve the requested data, and deliver them to the client 34 over the network 32. The transfer may be through TCP or UDP, and data transmitted from the server may be unicast to requesting clients or available for multicasting to multiple clients at once through a multicast router.

In accordance with the invention, the server 36 contains several components or systems including a virtual set generator 38, a virtual set database 40, a video processor and compressor 42, and a positional data calculator 44. These components may be comprised of hardware and software elements, or may be implemented as software programs residing and executing on a general purpose computer and which cause the computer to perform the functions described in greater detail below.

Producers of multimedia content use the virtual set generator 38 to develop a three-dimensional model of a set. The model may be based on recorded video of an actual set or may be generated completely based upon computer generated graphical objects. In some embodiments, the virtual set generator includes a 3D renderer. 3D Rendering is a process known to those of skill in the art of taking mathematical representations of a 3D world and creating 2D imagery from these representations. This mapping from 3D to 2D is done in an analogous way to the operation of a camera. The 3D renderer maintains data about the objects of a 3D world in 3D space, and also maintains the position of a camera in this 3D space. In the 3D renderer, the process of mapping the 3D world onto a 2D image is achieved using matrix mathematics, numerical transforms that determine where on a 2D plane a point in 3D space would project. Meshes of triangles in 3D space represent the surface of objects in the 3D world. Using the matrices, each vertex of each triangle is mapped onto the 2D plane. Triangles that do not fall onto the visible part of this plane are ignored and triangles which fall partially onto this plane are cropped.

The 3D renderer determines the colors for the 2D image using a shader that determines how the pixels for each triangle fall onto the image. The shader does this by referencing a material that is assigned by the producer of the 3D world. The material is a set of parameters that govern how pixels in a polygon are rendered, such as properties about how this triangle should be colored. Some objects may have simple flat colors, others may reflect elements in the environment, and still others may have complex imagery on them. Rendering complex imagery is referred to as texture mapping, in which a material is defined with two traits—one trait being a texture map image and the other a formula that provides a mapping from that image onto an object. When a triangle using a texture mapped material is rendered, the color of each pixel in each triangle is determined by the formulaically mapped pixel in the texture map image.

Virtual sets generated by the set generator are stored in the virtual set database 40 on the server 36, so they may be accessed and downloaded by clients. Models of virtual sets may be considered persistent data, to the extent they do not change over time but rather remain the same from frame to frame of a video show. As a result, models of virtual sets are preferably downloaded from the server 36 to client 34 in advance of transmission of a given video to be inserted in the set. This reduced the bandwidth load required during transmission of the given video data.

The video processor and compressor 42 receives video data 22 recorded by a producer's cameras or generated by a producer through computer animation techniques known to those of skill in the art. In accordance with processes described in greater detail below, the video processor and compressor 42 performs a matting operation on the video to identify separate useful imagery in the video data from non-useful imagery, the useful imagery being that which contains the recorded or generated activity. The video processor 42 further reduces the video to a smaller size by eliminating all or part of the non-useful imagery, thus compressing it and reduced the bandwidth required for transmission of the video data.

The positional data calculator 44 receives position data 24 recorded or generated by the producer. The position data 24 relates the position the real or virtual camera to the actors in the active portion of the video data 22. As used herein, the term actor is intended to include any object such as a person, animal or inanimate object, which is moving or otherwise changing in the active portion of the video data 22. The positional calculator 44 uses the raw position data 24 to calculate the orientation of the camera with respect to the actor. The client uses this data to position and orient the 3D camera within the virtual set.

The compressed video data and calculated positional data is synchronized and transmitted by the server 36 to any client 34 requesting the data. The client 34 has memory device(s) for storing any virtual sets 48 concurrently or previously downloaded from the server 36, for buffering the video data 50 being received, and for storing the positional data 52. The client contains a video renderer and texture mapper 54, which may be comprised of hardware and/or software elements, which renders the video data within the corresponding virtual set at a location predefined for the virtual set and at a size and orientation as determined based upon the positional data. For example, the orientation of the camera relative to the actor is used to determine the viewpoint to which the three-dimensional model of the virtual set is rotated before rendering as a two-dimensional image. The resulting rendered video and virtual set, and any accompanying audio and other associated and synchronized media signals, is presented on a display 26 attached to the client 34.

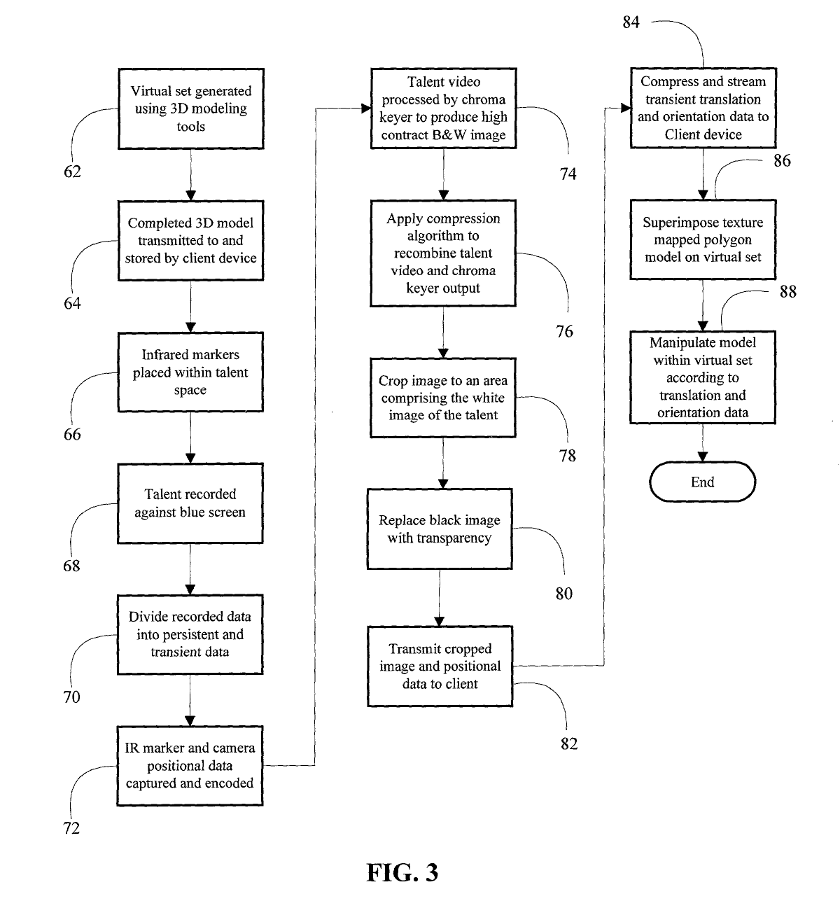

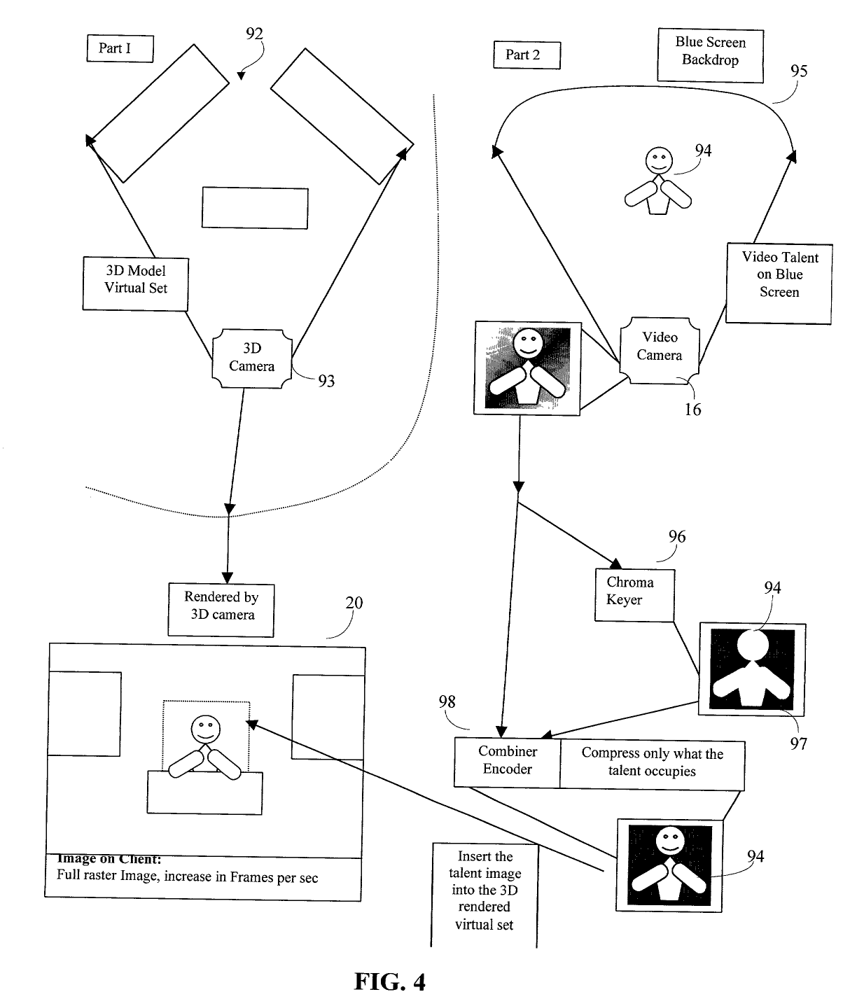

One embodiment of a process using the system of FIG. 2 is shown in FIG. 3 and further illustrated in FIG. 4. The virtual set is generated by a producer using 3D modeling tools, step 62, and the completed virtual set is transmitted to a client device for storage, step 64. The set and other imagery in which the talent is placed can be downloaded ahead of time and not retransmitted with every frame of video. Its texture map imagery is maintained in a known location in memory on the client. Any conventional 3D modeling tool may be used to generate the set, and the virtual set may be, for example, a 3D wireframe model or collection of object models with an image of the set mapped to it. A sample virtual set 92 is shown in FIG. 4 with reference to a virtual camera 93 that indicates the viewpoint from which the set may be viewed.

Talent is video recorded on a blue background, step 68, and the camera positional data is captured, step 72. Referring also to FIG. 4, by placing talent 94 on a blue background 95, the video of the talent recorded by a camera 16 can be sent to a chroma keyer 96, a stand alone piece of hardware on the server side of the connection. The chroma keyer generates high contrast black and white imagery 97, step 74 (FIG. 3), in which the talent 94 appears as a white stencil on a black background. A combiner/encoder 98 uses a video compression algorithm to recombine the video of the talent over the blue screen, and the output of the chroma keyer, step 76. The system thus detects where the talent is and is not. This consequently removes the need to encode black image data on the screen. The image is cropped down to a rectangle or other polygon comprising the white image of the talent, step 78, and the black imagery remaining inside the rectangle is transparent, step 80.

Only the rectangle the talent occupies is compressed and transmitted to the client, step 82, along with the positional data, step 84. Because the amount of video and other data transmitted is small, and the amount of data needed to represent the camera is small, transmission of the virtual set such as over the Internet takes better advantage of low bandwidth than existing video compression technologies. In some embodiments, the video portion of talent on a set is a small percentage of the total raster, typically 10-25%. With the smaller image, extra data space can be used to increase frame time or increase the resolution of the imagery or for the insertion of advertising.

The Client uses the compressed video as input into a texture map. A texture mapper is a 3D rendering tool that allows a polygon to have a 2D image adhered to it. The texture map's imagery is comprised of the transmitted video and subsequent changes on a frame-to-frame basis. The client decompresses the video and places it in the known location within the virtual set, step 86. This image can comprise both color and transparency. Where there is blue screen the texture map is transparent. Where there is no blue the pixels of the talent appear. This rendered image gives the impression that the talent is in the virtual set.

The client uses the virtual set camera position to position the 3D renderer's camera and manipulate the virtual set, step 88. By matching the 3D camera's position to the real camera's position, the video retains its dimensionality. By tracking the real camera on the blue set and transferring this data to the 3D camera in the 3D virtual set, real motion on the real set becomes virtual motion on the virtual set.

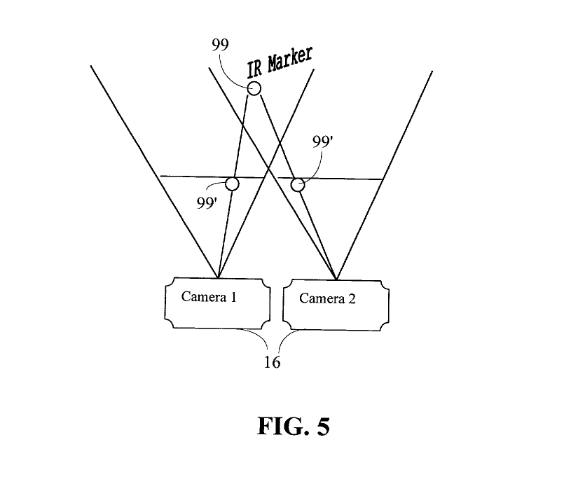

As explained above, the position of the camera within the blue set is tracked by placing infrared markers at strategic positions on the camera. Infrared sensitive cameras positioned at known stationary points in the blue set detect these markers. The position of these markers in 3D space in the blue set is detected by triangulation. FIG. 5 is a top down view of two 2D cameras 16 taking the position of an infrared marker 99. Both cameras 16 have unique views represented by the straight lines vectoring from the cameras in FIG. 5. These lines indicate the plane on which the real world is projected in the camera. Both cameras are at known positions. The circles 99′ on the fields of view represent the different points at which the infrared marker 99 appears on the cameras. These points are recorded and used to triangulate the position of the marker in 3D space, as known to those of skill in the art.

Because a virtual set tells which part of the screen is useful, the amount of bandwidth required to deliver each frame to the client is greatly reduced. The processing and compression of the video data as described herein reduces the video data transmitted to the client from full raster, full video screen, edge to edge, top to bottom, to only the amount where the action is taking place. Only a small portion of the raster has to be digitized. In addition, because the persistent data with regard to the show is pre-transmitted and already resides on the client, the system and method of the present invention are able to do more at a larger screen size with a higher resolution image than conventional compressed/streaming video are able to achieve.

In some embodiments, the system of the present invention is utilized with a media engine such as described in the commonly owned, above referenced provisional patent applications and pending application Ser. No. 60/117,394, titled “Media Engine.” Using the media engine and related tools, the producer determines a show to be produced, selects talent, and uses modeling or authoring tools to create a 3D version of a real set. This and related information is used by the producer to create a show graph. The show graph identifies the replaceable parts of the resources needed by the client to present the show, resources being identified by unique identifiers, thus allowing a producer to substitute new resources without altering the show graph itself. The placement of taps within the show graph define the bifurcation between the server and client as well as the bandwidth of the data transmissions.

The show graph allows the producer to define and select elements wanted for a show and arrange them as resource elements. These elements are added to a menu of choices in the show graph. The producer starts with a blank palette, identifies generators, renderers and filters such as from a producer pre-defined list, and lays them out and connects them so as to define the flow of data between them. The producer considers the bandwidth needed for each portion and places taps between them. A set of taps is laid out for each set of client parameters needed to do the broadcast. The show graph's layout determines what resources are available to the client, and how the server and client share filtering and rendering resources. In this system, the performance of the video distribution described herein is improved by more optimal assignment of resources.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for distributing video over a network for display on a client device, the method comprising:
storing model data representing a set in which action occurs;
generating video data representing action occurring;
capturing positional data representing a position of a camera during the action in generated video; and
transmitting from a server to the client device as separate data items the model data, generated video, and positional data, to thereby enable the client device to reproduce and display a video comprising the action occurring at certain positions within the set.

2. The method of claim 1, comprising transmitting the model data in advance of the video and positional data.

3. The method of claim 2, comprising the client device persistently storing the transmitted model data for use with a plurality of video and positional data items.

4. The method of claim 1, comprising, prior to transmission to the client, cropping the generated video data to eliminate some or all portions of the video in which no action occurs.

5. The method of claim 4, wherein cropping the generated video data comprises matting the video to separate the action from other portions of the video data.

6. The method of claim 5 wherein matting the video comprises generating a high contrast black and white image of the video wherein a white portion of the image represents the action, and cropping out all or part of a black portion of the image.

7. The method of claim 6, wherein generating a high contrast image comprises processing the video using a chroma keyer.

8. The method of claim 7, wherein generating the video data comprises recording action occurring in front of a blue screen, and wherein generating the high contrast image comprises using a chroma keyer on the recorded video.

9. The method of claim 1, wherein capturing positional data comprises capturing data representing the position of the camera with respect to the action in the video data.

10. A method for receiving video over a network and presenting it on a client device, the method comprising:
receiving from a server as separate data items model data representing a set in which action occurs, video data representing action occurring, and positional data representing the position of the camera during the action in the generated video;
rendering the video data within the set at a position within the set determined using the positional data to thereby produce the video; and
presenting the video on a client device.

11. The method of claim 10, wherein the model data comprises graphical data representing a three-dimensional virtual set.

12. The method of claim 11, wherein the graphical data is configured to be rendered as a two-dimensional image at a plurality of viewing angles relative to a virtual camera.

13. The method of claim 12, wherein the positional data comprises orientation data representing the position of the virtual camera relative to the action in the video data, and wherein rendering the video data within the set comprises selecting a viewing angle for the set using at least the orientation data.

14. The method of claim 11, wherein rendering the video data within the set comprises mapping the video data as a texture map onto the model data.

15. A method for distributing video over a network, the video representing an actor in motion, the set being represented in a three-dimensional rotatable model stored on a client connected to the network, the method comprising:
eliminating all or part of the video not containing the actor including matting the video to separate the actor from other parts of the video;
transmitting from a server to the client as separate data items the video and positional data representing the position of the real camera relative to the actor in the video;
the client receiving the video and positional data;
the client determining based upon the positional data whether to rotate the three-dimensional model of the set to properly orient the video therein, and rotating the model accordingly;
the client rendering the video within the rotated model at a depth determined based upon the positional data; and
the client presenting the rendered video and set.

16. A system for preparing a video for distribution over a network to one or more clients, the video containing one or more actors, the system comprising:
a positional data capturing system for capturing position data representing a position of the one camera relative to the actors in the video;
a video compression system for reducing the video by eliminating all or a portion of the video not containing the actor, the video compression system including a matting system for matting the video to separate the actor from other parts of the video; and
a transmission system for transmitting compressed video in association with corresponding positional data in association with model data representing a set within which the video is rendered for presentation by one or more clients.
